(19) United States
(12) Patent Application Publication
(10) Pub. No.: US 2019/0089789 A1
(43) Pub. Date: Mar. 21, 2019

(54) ESTABLISHMENT OF A DATA CONNECTION

(71) Applicant: BSH HAUSGERAETE GMBH, MUENCHEN (DE)

(72) Inventors: JAN PHILIPP DOERNER, MUENCHEN (DE); NIELS KUSCHINSKY, MUENCHEN (DE); NICK FLOHRER, MUENCHEN (DE)

(21) Appl. No.: 16/098,941

(22) PCT Filed: Apr. 11, 2017
(86) PCT No.: PCT/EP2017/058647

§ 371 Date: Nov. 5, 2018

(30) Foreign Application Priority Data
May 3, 2016 (DE) 10 2016 207 602.7

(51) Int. Cl. H04L 29/08; H04W 4/70

(52) U.S. Cl. CPC H04L 67/141; H04W 88/02; H04W 4/70

(57) ABSTRACT

A method connects a communication module to a network-based service. The method includes providing first access data for establishing a data connection between the communication module and a network component, and providing second access data for the use of a service that can be accessed via the network component. The first and second access data are transmitted to the communication module and a message from the communication module is transmitted to the service via the network component. The transmission of the access data to the communication module is executed as a tone sequence.

The invention relates to the establishment of a data connection between a communication module and a network-based service. Furthermore, the invention relates to the provision of a system comprising the two components.

In order to connect a conventional computer or a mobile device to a network-based service, access data must usually be input into the mobile device in order to enable a data transfer. The input of the access data is frequently straightforward when the device has sufficiently dimensioned input and output interfaces for a user. For example, the mobile device can comprise a smartphone with a touch screen, which is well-suited for manual input and optical verification of the access data.

In a similar manner to the mobile device, a household appliance can also be connected to a network-based service in order to exchange information therewith. The data connection is normally established once when the household appliance is assembled or set up. In order to input the required access data into the household appliance, usually no general operating elements such as a touch screen are available, but at most operating elements can be used which are otherwise provided only for controlling the household appliance. The input can be correspondingly time-consuming and error-prone.

US 2006282649 A1 proposes data-coupling two devices to one another by transmitting authorization data to one of the devices as a sound sequence in order to produce the connection.

US 2012184216 A1 proposes acoustically communicating the successful establishment of a data connection between two devices.

US 2015/00099470 A1 describes the establishment of a data connection between two devices by means of two-sided exchange of acoustic information.

The procedures described are frequently not readily applicable to a household appliance. In particular when the household appliance is not intended to establish contact with another device or service directly, but via an interposed network component, it can be necessary to provide a plurality of items of access information in order to establish the connection to the service. If the household appliance does not itself have a network access, an external communication module can be used, which is not connected to operating elements of the household appliance and frequently itself comprises no or only extremely rudimentary operating elements. Establishment of the connection can then be complicated and highly error-prone.

It is an object of the present invention to provide a technique in order to connect a communication module for a household appliance to a network-based service in an improved manner and to thus provide a system, which comprises the communication module and the service. The invention solves this object by means of the subject matters of the independent claims. Subclaims represent preferred embodiments.

An inventive method for connecting a communication module to a network-based service comprises steps of providing first access data for establishing a data connection of the communication module to a network component, the provision of second access data for the use of a service which can be reached via the network component, transmitting the first and second access data to the communication module, and transmitting a message from the communication module to the service via the network component. In this case, the first and second access data is transmitted to the communication module as a sound sequence.

Recording of the sound sequence by the communication module can be enabled in a simple manner by means of an acoustic input device, for example by means of a microphone. The sound sequence can lie in the audible range, so a user can monitor the transmission of the data directly. The sound sequence can comprise modulated sounds, for example according to the multi-frequency method MFM, which is known from telephony. By means of the sound sequence, a sufficiently large amount of information can be transmitted to the communication module within a short time in order to provide the first and second access data. The communication module can extract the first and second access data from the received sound sequence and, in a first step, establish a network connection to the network component, which can be designed in particular as a WLAN router. As a result, the use of a wide area network, for example of the Internet, can already be possible by the communication module. In a second step, the communication module can be registered with the service, in particular if the service is reachable via the Internet. In this case, the communication module can be authenticated with respect to the service, so data, which is subsequently exchanged between the service and the communication module, can be uniquely assigned. In order to protect the data against interception or manipulation, the communication between the communication module and the service can additionally be encrypted. In one embodiment, the second access data comprises a corresponding communication key.

The sound sequence can be transmitted in particular by means of a mobile device, for example a smartphone. For this purpose, the mobile device can have an acoustic output device, in particular a loudspeaker. Such a mobile device can be adapted to perform an interaction with a user in order to suitably collect the first and second access data in the mobile device before a transmission to the communication module takes place. For collecting, an appropriate computer program (application, app) can be executed on the mobile device. Parts of the first or second access data can also be automatically collected or provided, for instance on the basis of a communication with the network component or the service, or because the information is already known to the mobile device. After the service has received the message from the communication module it can send a confirmation message to the mobile device. The confirmation message can comprise additional information, for example that which has been transmitted by the communication module, and the confirmation message can be appropriately prepared and presented by the mobile device for a user.

In a further embodiment the mobile device determines the second access data for using the service based on a further message received from the service. This message can, for example, be sent from the service to the mobile device if a user purchases, personalizes or registers the communication module. In one embodiment the second access data comprises a one-time password in order to allow a connection to be established once. After the first use of the one-time password, the validity thereof lapses, so there is no real threat of misuse of an intercepted one-time password by third parties.

In yet a further embodiment the mobile device requests the message pointing to the second access data in the service. This request can comprise information which is specific to the communication module. The message generated by the service can comprise this information or be based thereon, so the transmitted second access data is practically personalized for the communication module. For this purpose, for example, a serial number of the communication module can be specified.

It is further preferred that the communication module is adapted to determine information, which points to an operating state of an associated household appliance, and to transmit it to the service. The request of the message pointing to the second access data can comprise an identification of the household appliance. As a result, the service can at the same time be prepared such that data transmitted later is associated with the operating state of a particular type of household appliance, for example a dishwasher or a coffee machine, or the information can be associated with a specific device. For example, a purchase date, features or repairs possibly carried out can be determined by the service on the basis of a serial number of a household appliance and can be included in processing of the transmitted information. Knowledge of the type of household appliance can be important for the interpretation of particular information of the communication module.

The service can answer the message from the communication module and the communication module can display an indication of receipt of the response. A simple display can occur, for example by means of a light-emitting diode or an acoustic output device, which can each be used cost-effectively and with little effort on the communication module.

An inventive communication module comprises a wireless data interface, an acoustic input device and a processing device. The processing device is adapted to control receipt of a message transmitted as a sound sequence by means of the input device, to extract first and second access data from the received message, to establish a data connection with a network component on the basis of the first access data by means of the data interface, and using the second access data, to transmit a message to a service which can be reached via the network component.

The communication module can be adapted to carry out the method described above. For this purpose, the processing device can comprise, in particular, a programmable microcomputer or microcontroller, and the method can run in the form of a computer program product on the processing device.

The communication module can be used to data-link an otherwise non-network-compatible household appliance to a network-based service in a simple and cost-effective manner. For this purpose, the communication module can be constructed in a simple and cost-effective manner. An interface to a user can likewise have an inexpensive design or even be omitted completely. The data can be transmitted inexpensively to a local network component, so, for example, an interface to a mobile radio network, which can be cost-intensive, can be omitted.

In a preferred embodiment the communication module is adapted for autonomous operation and is not connected to data or energy connections of the household appliance. The communication module is adapted to be attached to a device side of the household appliance and to determine an operating state of the household appliance on the basis of emissions of a functional component of the household appliance during its operating program. For example, the operating state of a tumble dryer can be determined on the basis of magnetic emissions of its drive motor.

However, it is also possible to integrate the communication module with the household appliance. For this purpose, the communication module can be arranged in particular on an inner side of a device housing of the household appliance and there can be an energy or data connection between the household appliance and the communication module. In one embodiment a control device of the household appliance is integrated with the communication module.

An inventive system comprises the described communication module, a network component and a service which can be reached by the network component. The system can be easily stepped up and reconfigured by the described method. In particular, many communication modules can be added to the system in a simple manner.

It is further preferred that the system additionally comprises a mobile device which is adapted for communication with the service. The mobile device can comprise a smartphone on which a specially provided application can run in order to carry out the described method.

The invention has been explained with reference to a method, a communication module and a system. Unless indicated otherwise, the features of one category of claims can be applied analogously to the subject matters of the other categories of claims.

The invention will now be described in more detail with reference to the accompanying figures, in which:

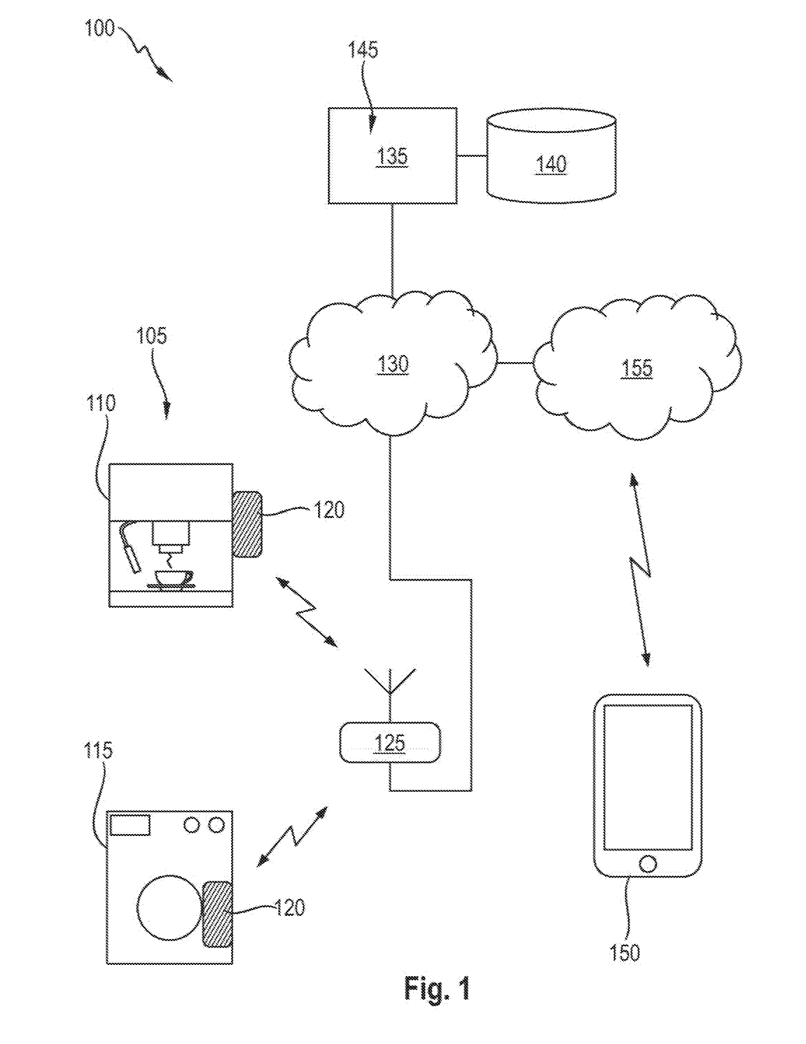

FIG. 1 shows a system comprising a plurality of household appliances;

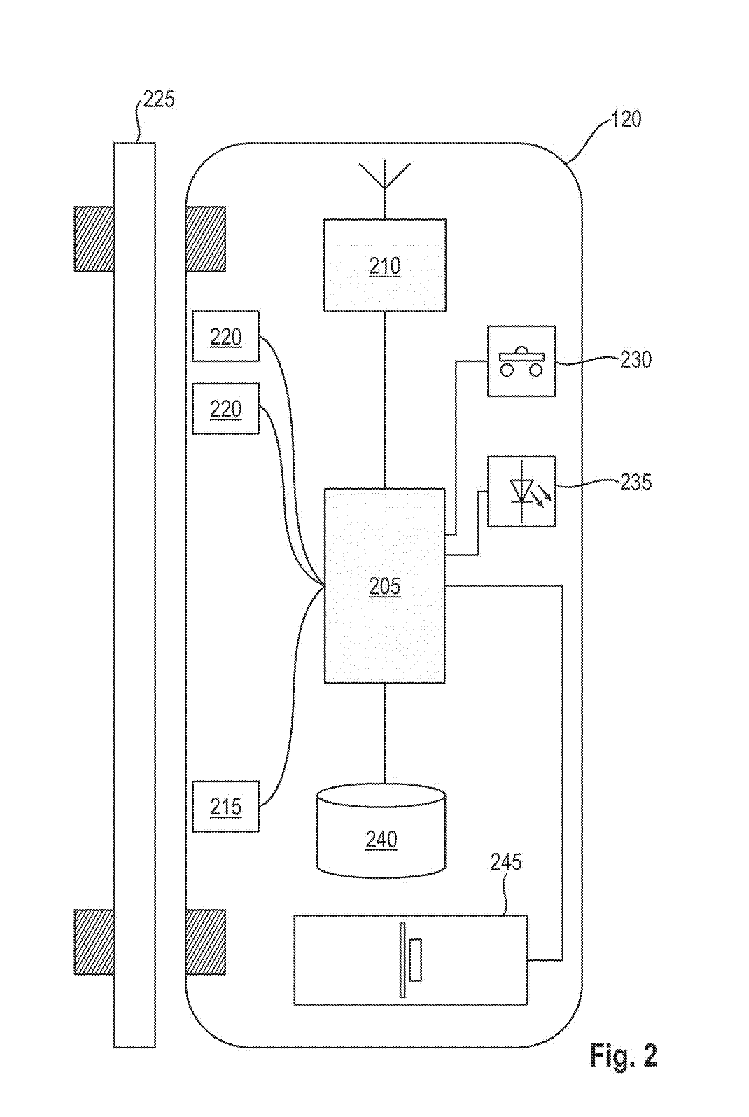

FIG. 2 shows a communication module for use on a household appliance; and

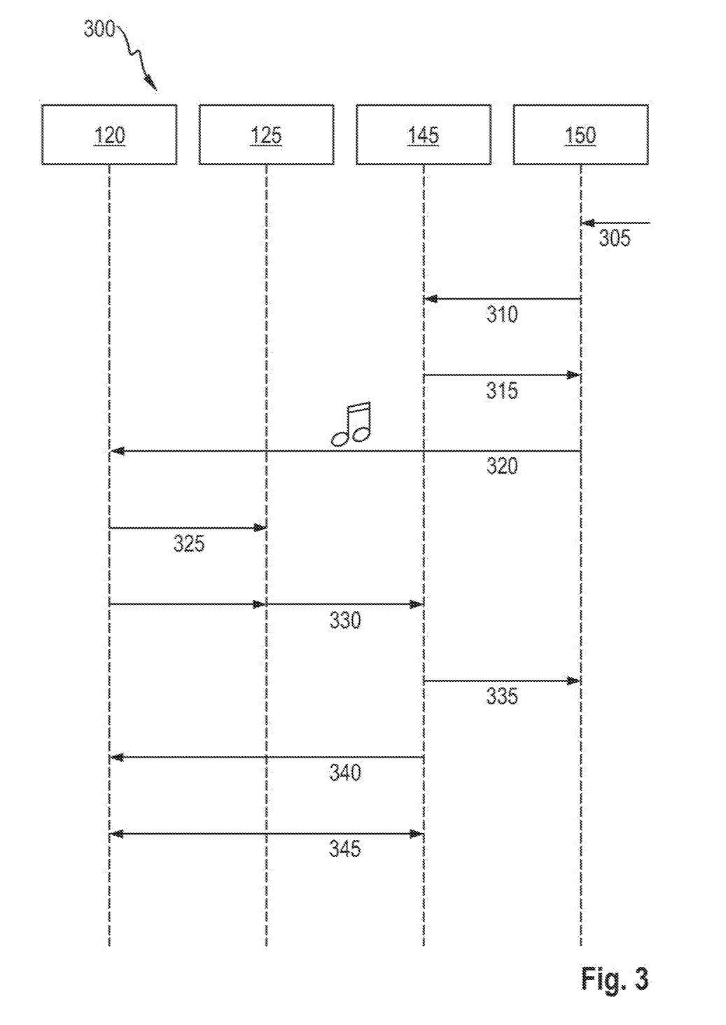

FIG. 3 shows a flowchart of a method for establishing a connection between a communication module of FIG. 2 and a network-based service.

FIG. 1 shows a system 100 having a plurality of household appliances 105. By way of example, a coffee machine 110 and a washing machine 115 are illustrated, however other household appliances are likewise possible. A communication module 120, which is described in more detail below with reference to FIG. 2, is attached to each of the household appliances 105. In one embodiment the communication module 120 is incorporated by the respective household appliance 105, in a further, preferred embodiment the communication module 120 is adapted to be attached to the outside of a device housing of the household appliance 105 and by means of a sensor device to sample an emission signal which a component of the household appliance 105 emits, which component carries out a drive process of the household appliance 105. The component can, for example, comprise a heater or an electric motor, and the sensor device can be adapted to scan the temperature or a magnetic radiation. In each case, it is preferred that the communication module 120 is adapted to determine and provide an operating state of the household appliance 105.

A network component 125 is adapted to impart or provide a communication to a network 130. In this case, the network component 125 is conventionally associated with the same household as the household appliances 105. The network 130 can be part of the Internet or vice versa, and the communication module 120 can establish a wireless connection to the network component 125 in order to exchange information with a further component which can be reached via the network 130. The network component 125 preferably comprises a WLAN router, which comprises a conventionally wired connection to the network 130, which is designed, for example, as an Ethernet, DSL or fiber optic-based connection.

A central component 135 comprises a data memory 140 and can be accessed via the network 130. A service 145, which can be virtualized as what is known as a cloud-based service, runs on the central component 135, so it is irrelevant to a user whether it runs on the illustrated central component 135 or another component, which can be reached via the network 130. The service offers a predetermined functionality, which usually comprises a type of processing or storage of data which the service receives from the communication module 120.

The system 100 can also comprise a mobile device 150 adapted, in particular, for interaction with a user. For this purpose, the mobile device 150 can comprise, for example, a touchscreen or other input or output devices. In addition, it is preferred that the mobile device 150 has an acoustic output device, in particular a loudspeaker. It is preferred that the mobile device comprises 150 a smartphone. The mobile device 150 can access the network 130 via the network component 125 or a dedicated network, for example a mobile radio network 155.

In order to step-up the system 100 it is necessary to establish communication between the communication module 120 and the service 145. Communication is usually established once and a once-established connection can be retained thereafter or re-established as required. If the initial establishment of the connection was successful, the following establishment of the connection usually no longer represents a problem.

In order to establish a data connection between the communication module 120 and the service 145, the communication module 120 is provided with first and second access data. The first access data is required in order to establish a data connection with the network component 125. This data can comprise, for example, a network name (service set identifier, SSID) and an authentication, for example according to BPA2. The second access data can be used to utilize the service 145. For example, the second access data can have a network address (uniform resource locator, URL) of the service 145, a user name and/or a password.

The first and second access data is preferably transmitted to the communication module 120 on an acoustic path in the form of a sound sequence. For this purpose, the access data can be prepared beforehand, for example on the mobile device 150. In particular, the first access data can be input manually at the mobile device 150 for accessing the network component 125. Parts of the second access data can be requested by the mobile device 150 from the service 145. In this request, different personalizations or protection functions are possible in order to ensure that ultimately a personalized or protected connection is established between the communication module 120 and the service 145.

FIG. 2 shows an exemplary communication module 120 for use on a household appliance 105. The communication module 120 comprises a processing device 205, a wireless data interface 210 and an acoustic input device 215. The input device 215 can be designed, in particular, as a microphone.

It is preferred that at least one sensor device 220 is additionally provided in order to scan a parameter of an associated household appliance 105 from which an operating state of the household appliance 105 can be determined. In one embodiment one of the sensor devices 220 is designed as a data interface 210, so the operating state can be determined or obtained directly, for example by a control device of the household appliance 105.

In a further embodiment the communication module 120 is arranged mechanically on the outside of a device housing of the household appliance 105, so the operating state has to be determined by means of scanning emissions of components of the household appliance 105. For this purpose, different sensor devices 220 can be provided, for example a vibration sensor, an acceleration sensor, a rotation rate sensor, a magnetic field sensor, a temperature sensor, an infrared sensor, a VOC sensor (VOC: volatile organic compounds), an air humidity sensor, a water sensor or a camera.

The communication module 120 can be mechanically fastened by means of an adapter 225, which can be attached in particular to the outside of a device housing of the household appliance. In one embodiment, no input or output devices are provided on the communication module 120 for interaction with a user. In a further embodiment an at least simple input device such as a pushbutton 230 or an at least simple output device such as a light-emitting diode 235 can be provided.

The communication module 120 optionally comprises a memory 240, for example for storing measured values of a sensor device 215, 220 or a specific operating state. The communication module is supplied with energy preferably by means of a battery or an accumulator 245.

FIG. 3 shows a flowchart of a method 300 for establishing a connection between a communication module 120 such as that of FIG. 2 and a network-based service 145, as in FIG. 1. Parts of the method 300 can run on the communication module 120 and in particular on the processing device 205.

Vertical interrupted lines represent the communication module 120, the network component 125, the service 145 and the mobile device 150. Horizontally drawn arrows represent messages which are exchanged between the components 120, 125, 145 and 105 during the course of the method 300. In this case, variations to the illustrated sequence and to the illustrated scope are possible.

In an optional step 305, first access data can be input, for example by a user, into the mobile device 150 or otherwise aggregated therein in order to use the network component 125. Further information can optionally also be input, which relates in particular to the communication module 120 or the household appliance 105 associated with it. For example, a serial number of the communication module 120 or of the household appliance 105, a type specification of the household appliance 105 or another indication of the household appliance 105 is input. Second access authorizations, which can be used in order to utilize the service 145, can likewise be input manually in step 305. Said information can be freely available, for example, or can be obtained by a user from the service 145. The information can comprise, for example, a user identifier and a password.

In a further embodiment the second access data is requested at least partially by the mobile device 150 in the service 145 in a step 310. The request can comprise information which points to the communication module 120 used, the household appliance 105 or a user of the service. For example, a user can create a profile in the service 145, be provided with a user name and a password, and install a household appliance 105 logically within the service 145. The service 145 can respond with information in a step 315, which comprises at least part of the second access data or points to said second access data. In one embodiment a one-time password is transmitted back from the service 145 to the mobile device 150, which password can be determined on the basis of the information transmitted in the opposite direction in step 310.

In a step 320, the first and second access data is transmitted from the mobile device 150 to the communication module 120 acoustically, in a non-verbal manner. The transmission can in particular comprise a sound sequence and each sound can be combined from a plurality of frequencies, as is known, for example, from the sound selection with a telephone. The transmission can be expanded by additional security codes, checksums, a correction code, a message header or an end-of-message. In one embodiment the communication module 120 is prepared for transmission of the access data by pressing the button 230. The communication module 120 can then activate the acoustic input device 215 and receive the acoustically transmitted information.

In a step 325, the communication module 120 uses the first access data for establishing communication with the network component 125. In a subsequent step 330, the communication module 120 uses the second access data in order to use the service 145, log on or establish a communication with it. Corresponding data is routed via the now established connection to the network component 125 and conventionally to the network 130.

In an optional step 335, the service 145 transmits a confirmation to the mobile device 150 so a user of the mobile device 150 knows that communication between the communication module 120 and the service 145 has been successfully established. Independent of this, a confirmation from the service 145 can also be sent to the communication module 120 in a step 340. The arrival of the confirmation message can be indicated by the communication module 120 to the outside, for example by switching on or blinking of the light-emitting diode 235. The communication module 120 and the service 145 can subsequently exchange data with one another in a step 345. This data can in particular comprise an operating state of the household appliance 105 associated with the communication module 120.

The explanations given with reference to the figures are to be understood as being purely illustrative and should not be understood as being restrictive. A large number of changes can be made to the described embodiments without departing from the scope of the invention as defined in the attached claims.

### LIST OF REFERENCE CHARACTERS

100 System

105 Household appliance

110 Coffee machine

115 Washing machine

120 Communication module

125 Network component

130 Network

135 Central component

140 Data memory

145 Service

150 Mobile device

155 Mobile radio network

205 Processing device

210 Wireless data interface

215 Acoustic input device

220 Sensor device

225 Adapter

230 Pushbutton

235 Light emitting diode

240 Memory

245 Accumulator

300 Method

305 Inputting 1^{st} access data, possibly device type into mobile device

310 Requesting of 2^{nd} access data from the service by the mobile device

315 Transmission of 2^{nd} access data to the mobile device

320 Transmission of 1^{st} and 2^{nd} access data from the mobile device to the communication module

325 Transmission of 1^{st} access data from the communication module to the network component

330 Transmission of 2^{nd} access data from the communication module to the service

335 Transmission of confirmation from service to mobile device

340 Transmission of confirmation from service to communication module

345 Data exchange between communication module and service

1-9. (canceled)

10. A method for connecting a communication module to a network-based service, the method which comprises the following steps of:
providing first access data for establishing a data connection of the communication module to a network component;
providing second access data for using the network-based service reachable via the network component;
transmitting the first and second access data to the communication module, the transmitting of the first and second access data to the communication module takes place as a sound sequence; and
transmitting a message from the communication module to the network-based service via the network component.

11. The method according to claim 10, which further comprises transmitting the sound sequence by means of a mobile device having an acoustic output device and the network-based service, after receiving the message from the communication module, sends a confirmation message to the mobile device.

12. The method according to claim 11, which further comprises determining, via mobile device, the second access data on a basis of a further message received by the network-based service.

13. The method according to claim 12, wherein the mobile device requests the further message pointing to the second access data at the network-based service by means of a request.

14. The method according to claim 13, which further comprises adapting the communication module to transmit information relating to an operating state of a household appliance associated with the communication module and to transmit the information to the network-based service, and wherein the request comprises an identification of the household appliance.

15. The method according to claim 10, wherein the network-based service answers the message of the communication module by means of a response and the communication module displays an indication of receipt of the response.

16. The method according to claim 11, wherein the acoustic output device is a loudspeaker.

17. A communication module, comprising:
a wireless data interface;
an acoustic input device; and
a processing device adapted to:
control receipt of a message transmitted as a sound sequence by means of said acoustic input device;
extract first and second access data from a received message;
establish a data connection with a network component on a basis of the first access data by means of said wireless data interface; and
use the second access data to transmit a further message to a service which can be reached via the network component.

18. The communication module according to claim 17, wherein said acoustic input device is a microphone.

19. A system, comprising:
a network component;
a service which can be accessed by said network component; and
a communication module having a wireless data interface, an acoustic input device, and a processing device adapted to:
control receipt of a message transmitted as a sound sequence by means of said input device;
extract first and second access data from a received message;
establish a data connection with said network component on a basis of the first access data by means of said wireless data interface; and
use the second access data to transmit a further message to said service which can be reached via said network component.

20. The system according to claim 19, further comprising a mobile device being adapted to communicate with said service.
